(19) United States
(12) Patent Application Publication
(10) Pub. No.: US 2005/0195851 A1
(43) Pub. Date: Sep. 8, 2005

(54) System, apparatus and method of aggregating TCP-offloaded adapters

(75) Inventors: Dwip N. Banerjee, Austin, TX (US); Vinit Jain, Austin, TX (US); Jorge Rafael Nogueras, Austin, TX (US); Vasu Vallabhaneni, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/777,715

(22) Filed: Feb. 12, 2004

(51) Int. Cl. H04J 3/16; H04L 12/66

(52) U.S. Cl. 370/437; 370/463

(57) ABSTRACT

A system, apparatus and method of aggregating TCP-offloaded adapters are provided. When data is being transacted between a local host and a remote host, associated with the data are usually a local port and a remote port through which the data transaction is to occur. If any one or both hosts have a plurality of TCP-offloaded adapters, the adapters may be aggregated by assigning a common IP address to the adapters. Then an adapter is selected through which the data transaction will occur based on the local port and the remote port. Specifically, the port numbers of the two TCP ports are added together and modded (i.e., the sum-undergoes a modulo operation) by the number of adapters in the aggregation. The result of the modulo operation determines which TCP-offloaded adapter is used to handle the data transaction.

### BACKGROUND OF THE INVENTION

1. Technical Field

The present invention is directed to network communications. More specifically, the present invention is directed to a system, apparatus and method of aggregating TCP-offloaded adapters.

2. Description of Related Art

With the advent of high bandwidth-consuming applications such as on-line content, e-commerce, network databases, streaming media etc., network connection bandwidth requirements for ISPs (Internet Service Providers), ASPs (Application Service Providers), streaming media providers have increased exponentially. One of the methods used to meet this increase in connection bandwidth requirements is link aggregation. (Note that a link, in this context, is a connection between a physical network port on one system to a physical network port on another or the same system.)

Link aggregation is a method by which physical network links are combined into a single logical link. Stated differently, link aggregation allows two or more links to be bundled together (i.e., aggregated) to form a group. In a link aggregation group of N links, there are N parallel point-to-point links. Therefore, if a host system has three 1 Gbits/sec Ethernet adapters, the host may transact data using all three adapters and thereby triple its network connection bandwidth.

However, there are certain disadvantages associated with link aggregation. For example, in traditional system architectures, hosts' processors process network data traffic as well as run applications. Therefore, the more time is spent processing network data traffic, the less time there is for running applications. With increases in TCP/IP (Transport Control Protocol/Internet Protocol) networking speeds, brought about by high speed Ethernet adapters and/or link aggregation among others, more time is spent processing network data. It is estimated that Gigabit Ethernet data traffic processing alone can consume nearly all of a host processor's cycles. This, obviously, robs a system of its performance.

To solve this problem, TCP data processing has, in some cases, been relegated (i.e., offloaded) to an embedded processor on the Ethernet adapters, freeing up the host processor for running applications and performing other tasks. However, due to the nature of TCP-offloaded adapters, they cannot be aggregated, defeating the purpose of link aggregation.

For example, when conventional Ethernet adapters are used in link aggregations, TCP data processing is handled by the host. Thus, TCP state information including memory for reassembling incoming data and memory for TCP send buffer etc. is stored in the host. Since the TCP state information is stored in the host and since the host performs the TCP data processing, the adapters may then be viewed as a data relay mechanism. Thus, any one of them may be used to relay data between a local host and a remote host.

In TCP-offloaded adapters, the TCP data processing is handled by the adapters. Thus, the TCP state information is contained exclusively on the adapter where the session originated. Consequently, it is not possible to send a data packet through one adapter and receive a reply belonging to the same TCP connection through another adapter since the latter will not have the TCP state information necessary to process the packet.

Thus what is needed is an apparatus, system and method of aggregating TCP-offloaded adapters.

### SUMMARY OF THE INVENTION

The present invention provides a system, apparatus and method of aggregating TCP-offloaded adapters. The system, apparatus and method include aggregating the TCP-offloaded adapters by assigning a common Internet Protocol (IP) address to the TCP-offloaded adapters. When a connection is to be established between a local host configured with an aggregated TCP-offloaded adapters and another host, one of the aggregated TCP-offloaded adapters through which a connection between the communications systems is to originate is first selected. After selecting the TCP-offloaded adapter through which to originate the connection, the connection will be established and data will be transacted using the selected TCP-offloaded adapter.

In a particular embodiment, the TCP-offloaded adapter is selected using a local port and a remote port, the local port and the remote port being the ports through which the data transaction is to occur. Particularly, when data is being transacted between a local host and a remote host, associated with the data are usually a local TCP port and a remote TCP port through which the data transaction is to occur. The port numbers of the two TCP ports are added together and modded (i.e., the sum undergoes a modulo operation) by the number of adapters in the aggregation. The result of the modulo operation determines which TCP-offloaded adapter is used to handle the data transaction.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts a link aggregation system.

FIG. 5(a) depicts layers of a communications system using a conventional adapter.

FIG. 5(b) depicts layers of a communications system using a TCP-offloaded adapter.

FIG. 5(c) depicts layers of a communications system in accordance with the present invention.

FIG. 6 is a flowchart of a process that may be used by an aggregation layer to select an adapter through which data is to be transmitted.

FIG. 7 is a flowchart of a process that may be used by a switch to route data packets to TCP-offloaded adapters.

### DETAILED DESCRIPTION OF THE PREFERRED EMBODIMENT

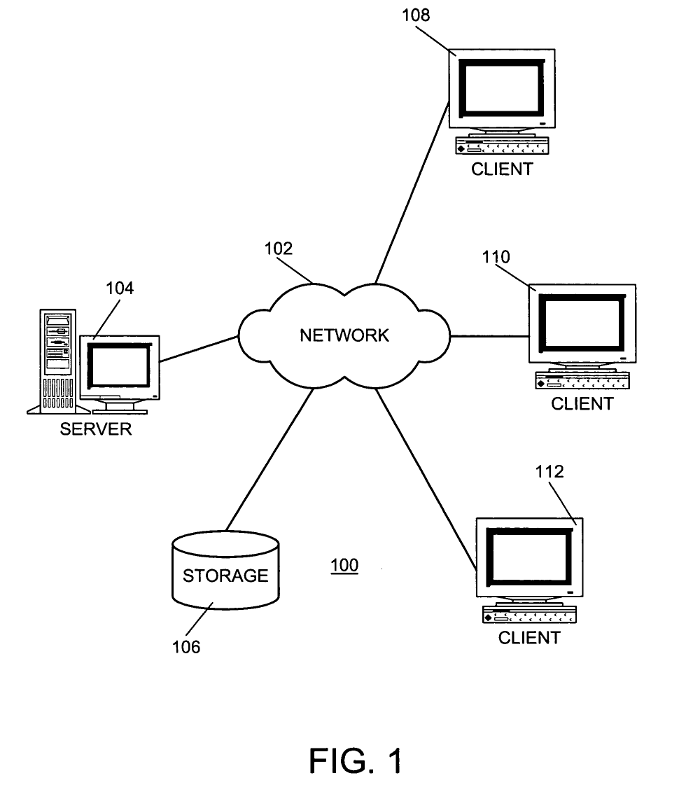

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

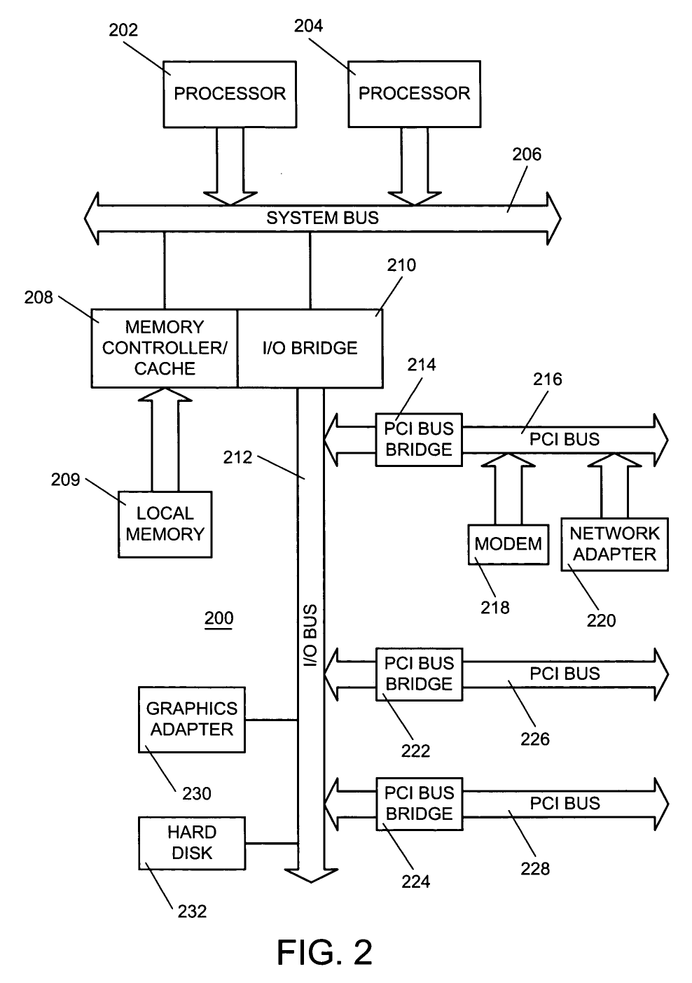

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, N.Y., running the Advanced Interactive Executive (AIX) operating system or LINUX operating system.

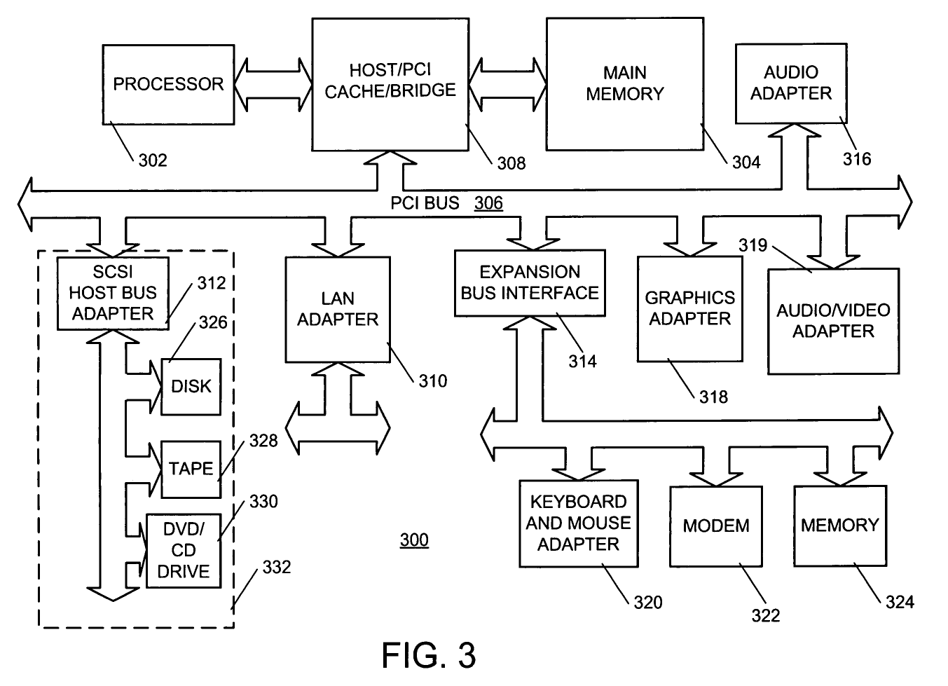

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM/DVD drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP™, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system, apparatus and method of aggregating TCP-offloaded adapters. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

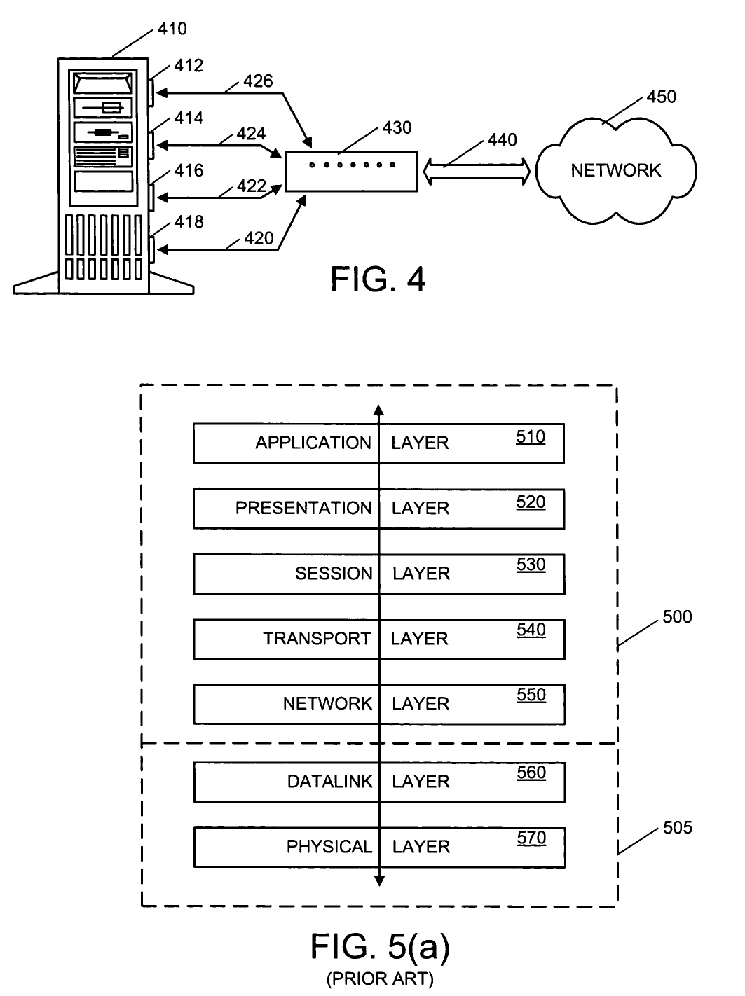

FIG. 4 depicts a link aggregation system. The link aggregation system contains a host 410 having four network interface cards (NICs) 412, 414, 416 and 418. The four NICs are connected to a switch 430 via links 420, 422, 424 and 426, respectively. The switch 430 is used to aggregate the four links into one high speed link 440 which may be connected to a network 450. Note that the host 410 may represent any one of the clients 108, 110 and 112 or the server 104 whereas network 450 may represent network 102 of FIG. 1.

In operation, the host 410 distributes data packets that are to be transmitted over the network 450 to the four NICs 412, 414, 416 and 418. When the switch 430 receives the packets from the NICs, it combines them into a single high speed signal before they are sent on the network 450. Thus, if the NICs 412, 414, 416 and 418 are each a 1 Gbits/sec Ethernet adapter, the speed of the high speed link 440 may be 4 Gbits/sec.

Oncoming data received by the switch 430 over the high speed link 440 is split into data streams to be sent to host 410 via NICs 412, 414, 416 and 418. When the host 410 receives the data streams, it recombines them to form the original oncoming data. Note that for simplicity reasons, NICs and adapters will be used interchangeably throughout the rest of the disclosure.

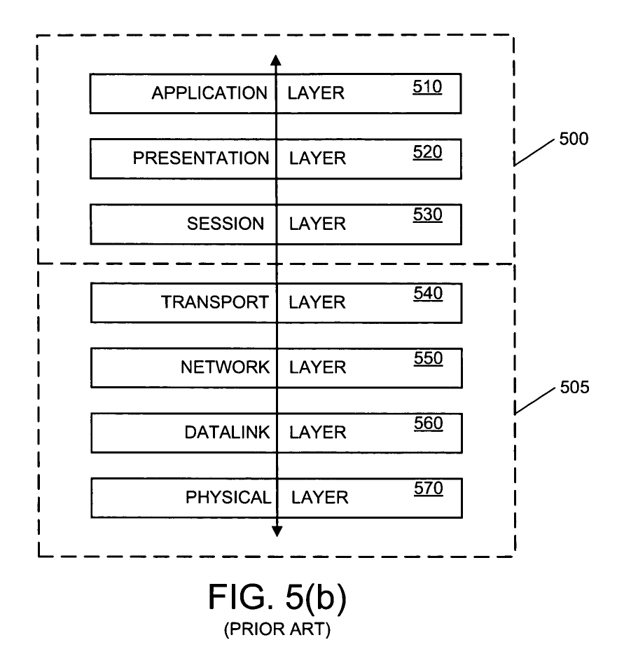

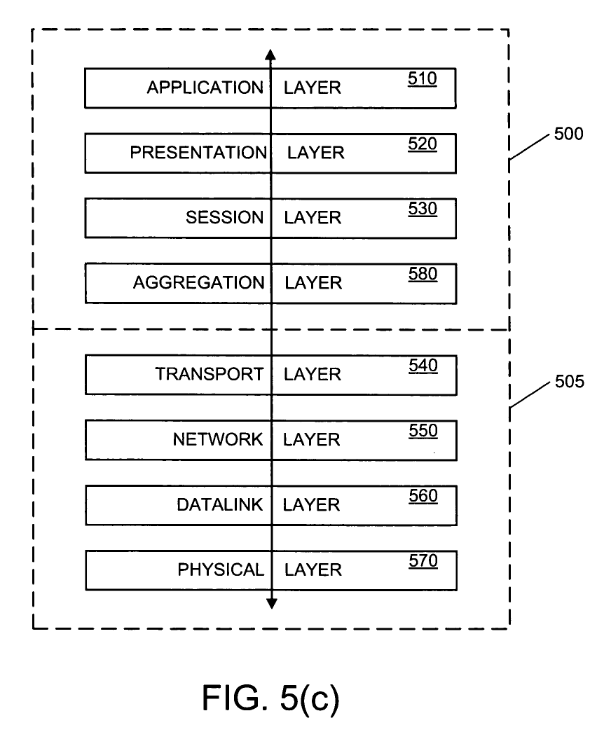

FIGS. 5(a), 5(b) and 5(c) depict a plurality of layers of a communications system. The layers are application layer 510, presentation layer 520, session layer 530, transport layer 540 network layer 550 data link layer 560 and physical layer 570.

The application layer 510 is the layer at which communication partners are identified, quality of service is identified, user authentication and privacy are considered and any constraints on data syntax are identified. The presentation layer 520 converts incoming and outgoing data from one presentation format to another (e.g., from a text stream into a pop-up window). The session layer 530 sets up, coordinates, and terminates conversations, exchanges dialogs between the applications at each end. The transport layer 540 manages the end-to-end control (for example, determining whether all packets have arrived) and error-checking. It ensures complete data transfer and thus TCP state information is processed and stored in this layer. The network layer 550 handles the routing of the data (i.e., sending the data in the right direction to the right destination on outgoing transmissions and receiving incoming transmissions at the packet level). The data-link layer 560 provides synchronization for the physical level and does bit-stuffing for strings of 1's in excess of 5. It furnishes transmission protocol knowledge and management. The physical layer 570 conveys the bit stream through the network at the electrical and mechanical level. It provides the hardware mechanism for sending and receiving data on a carrier.

As seen from the figures, the layers are divided in two groups, groups 500 and 505. The layers in group 500 are integrated into the host while the layers in group 505 are on an adapter. In FIG. 5(a), which depicts a system having a conventional adapter, the transport layer 540 is integrated in the host. Thus, the host handles the processing and storage of the TCP state information of all communications sessions. Accordingly, the TCP state information of any communication session between a local host and a remote host is available on the local host. Hence, data packets from any given connection received by the different adapters in FIG. 4 may accurately be processed by the local host.

By contrast, a TCP-offloaded adapter includes the transport layer 540 and the network layer 550 in addition to the layers that a conventional adapter usually contains (see FIG. 5b). In this case, TCP state information of a communication session is processed and stored on the adapter. Consequently, only the adapter through which the communication originated will contain the requisite TCP state information to properly process data packets for the session. Hence, TCP-offloaded adapters may not be used in link aggregation.

The present invention, however, provides a method by which TCP-offloaded adapters may be aggregated. To do so, the invention adds an eighth layer, aggregation layer 580 (see FIG. 5(c)). Aggregation layer 580 is placed above TCP-offloaded adapters and is aware that the adapters are TCP-offloaded adapters. Further, the aggregation layer 580 knows the IP address that is assigned to the adapters in a link aggregation and is directly involved in the process of setting up TCP connections between local hosts and remote hosts.

Each TCP/IP connection has a unique identifier. The identifier is a combination of local IP address, local port, remote IP address and remote port. A port is a logical channel or channel endpoint in a communications system. TCP and User Datagram Protocol (UDP) use ports to distinguish between different logical channels on the same network interface on the same computer. Thus, a local host may have two or more Web sessions in progress with a Web server, both on remote port 80, and the data from the sessions will not be inter-mixed so long as a different local port number is used for each one of the sessions.

Servers make their services available to the Internet using numbered ports, one for each service that is available on the server. For example, if a server is running a Web server and an FTP (File Transfer Protocol) server, the Web server will typically be available on port 80, and the FTP server on port 21. Thus, a client connects to a service at a specific IP address and on a specific port.

There are 65,535 ports available on each system. These 65,535 ports may be divided in three groups, groups I, II and III. Well-known services, such as Web server, FTP server etc., may be in group I. The ports in this group are usually referred to as well-known ports and may range from ports 0-1,023. The ports in Group II, which are known as registered ports, may range from ports 1024-49,151. Group III is the group of dynamic/private ports and may encompass ports 49,152-65,535. Note that this group port division is not meant to be restrictive to the invention. It is used for illustrative purposes only.

As mentioned above, an established connection between a local host and a remote host requires four (4) parameters (local IP address, local port, remote IP address and remote port). Three of these four parameters are generally set and known. The three parameters are the local IP address, the remote IP address and the remote port. However, unless the application running on the client that is establishing the connection explicitly designates a local port, an ephemeral port will be used.

Ephemeral ports are temporary ports assigned by a machine's IP stack, and are assigned from a designated range of ports. When the connection terminates, the ephemeral port is available for re-use, although most IP stacks won't re-use that port until the entire pool of ephemeral ports has been used. So, if the local host's program reconnects, it will most probably be assigned a different ephemeral port for the new connection.

During a TCP connection setup time, the application originating the connection will choose the remote port and the remote IP address based on the location of the remote host and the service to which the application is availing itself. Note that the remote TCP port for the connection generally is known since remote TCP ports tend to be well-known ports. Both the remote IP address and the remote port will be passed to the aggregation layer 580 which will in turn pass them to the adapters. The remote IP address is passed to the adapters to ensure that the adapters are configured properly since the adapter through which the session will originate is not yet known.

If the application also chooses the local TCP port for the connection, the application layer 510 will inform the appropriate adapter through the aggregation layer 580. If the application does not choose a local TCP port for the connection, which is the most common case, the aggregation layer 580 will select an unused ephemeral local port for the connection. After selecting the local port, the aggregation layer 580 will inform the appropriate adapter of the port selected.

When the application wishes to send data to the remote host, the aggregation layer 580 will select the adapter to use based on the local and remote ports of the TCP connection. For example, if the remote port is 80 and the local port is 5000 and there are four (4) adapters in the aggregation, the adapter that will be used is (80+5000) % 4=0 (i.e., the first adapter in the aggregation). If instead the local port is 5005 while the remote port remains 80 then the adapter that will be selected is (80+5005) % 4=1 (i.e., the second adapter in the aggregation) and so on. Note that since the aggregation layer 580 is aware of the local port chosen by the application or is itself the one choosing the local port, it can make sure that all local ports that are being used at any given time is unique on the local host. Note also, that any other formula or algorithm that has a resulting value in the range or the number of adapters in the aggregation may be used. Thus, the use of adding the local and remote ports together and using the number of adapters to “mod” the sum is only for illustrative reasons.

In any case, the Ethernet switch 430 also uses the same algorithm to determine which adapter should be receiving which packet of a high speed signal that contains a plurality of packets.

For applications that listen on certain ports, the aggregation layer 580 setup listening sockets on all adapters. A socket is a mechanism for creating a virtual connection between processes. A socket is identified by a socket address which consists of a port number and the local host's IP address. In any case, as the switch de-multiplexes the incoming packet data based on the local and remote ports, the incoming requests will be directed to the adapter where all subsequent packets for the connection will go. The aggregation layer 580 will close the listening sockets on all the adapters when the application wants to stop listening on that port.

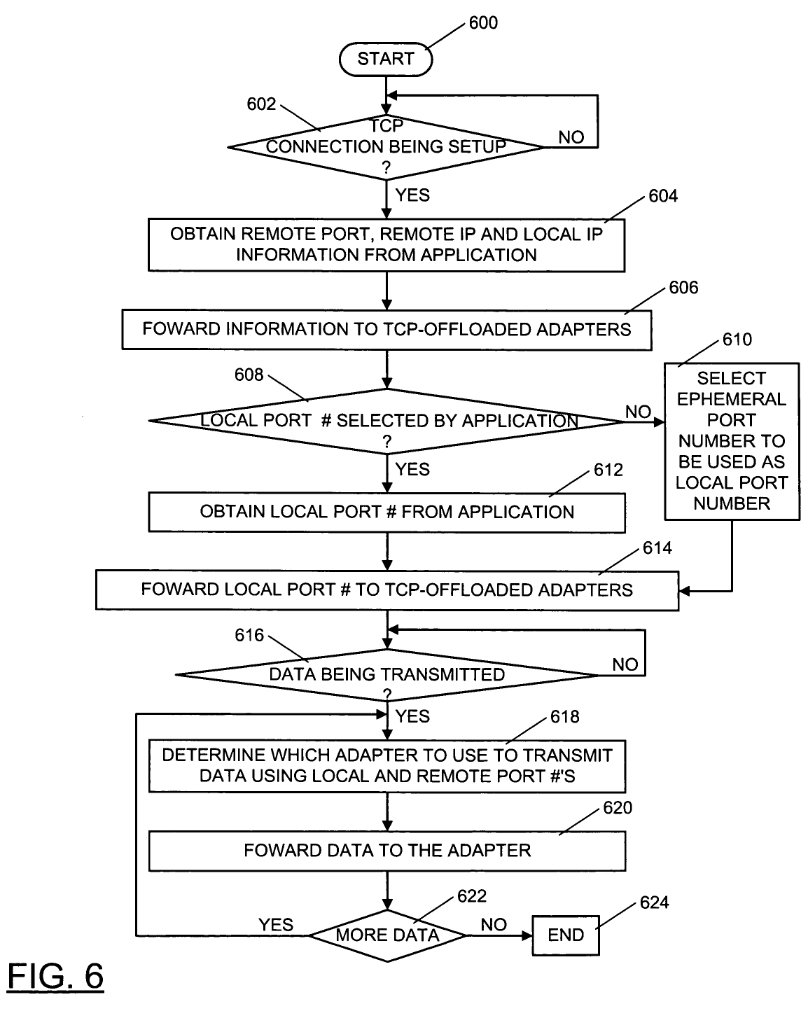

FIG. 6 is a flowchart of a process that may be used by an aggregation layer to select an adapter through which data is to be transmitted. The process starts when the host in which the process is implemented is turned on (step 600). The process will monitor applications that are running on the host to determine whether a TCP connection is being established. If so, the remote port, remote IP address and local IP address are obtained and forwarded to the adapters (steps 602, 604 and 606). The process will also determine whether the application establishing the TCP connection has selected a local port number. If so, it will obtain the local port number as well as forward it to the adapters. If the application has not selected a local port number, then the process will select a port number from a list of ephemeral port numbers and forward it to the adapters (steps 608, 610, 612 and 614). When data is ready for transmission, the process will determine through which adapter the data is to be transmitted by adding the local and report numbers together and mod (performing a modulo operation) the sum by the number of adapters in the aggregation. The result of the modulo operation determines the adapter that will be used. Once done, the data will be forwarded to the adapter. The process ends when the there is no more data to transmit or when the host is turned off (steps 616, 618, 620, 622 and 624).

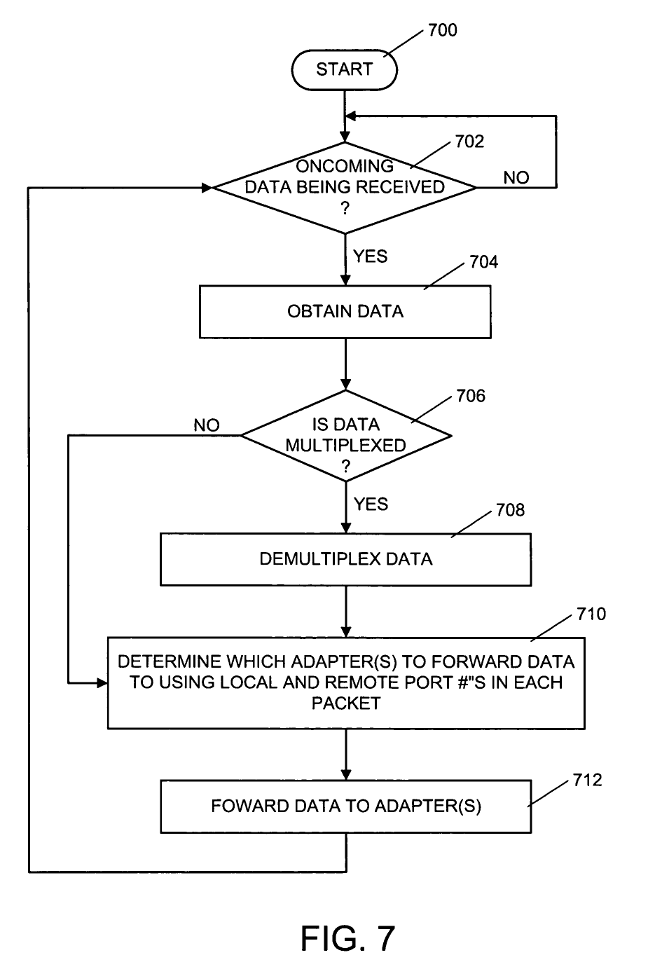

FIG. 7 is a flowchart of a process that may be used by a switch to route data packets to TCP-offloaded adapters. The process starts when the switch is turned on (step 700). Then, if the switch is receiving oncoming data, it will de-multiplex the data into data packets if the data is multiplexed. After de-multiplexing the data, the switch will obtain the local and remote ports from each de-multiplexed packet. The local and remote ports from each port are used to determine the adapter to which the packet is to be forwarded. The switch then forwards the packet to the identified adapter. The process will end when the switch is turned off (steps 702-712).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of aggregating TCP-offloaded adapters for transacting data between communications systems comprising the steps of:
aggregating the TCP-offloaded adapters by assigning a common Internet Protocol (IP) address to the TCP-offloaded adapters;
selecting one of the aggregated TCP-offloaded adapters through which a connection between the communications systems is to originate;
originating the connection using the selected TCP-offloaded adapter; and
transacting data from the connection using the selected TCP-offloaded adapter.

2. The method of claim 1 wherein the selecting step is based on a local port and a remote port, the local port and the remote port being the ports through which the data transaction is to occur.

3. The method of claim 2 wherein the selecting step includes the step of assigning a local port through which the connection is to occur if a local port was not yet assigned.

4. The method of claim 3 wherein the assigned local port is an ephemeral port.

5. The method of claim 1 wherein the data includes incoming and outgoing data, the incoming data being divided into data packets, each packet having associated therewith a local port and a remote port for selecting a TCP-offloaded adapter through which to travel.

6. A computer program product on a computer readable medium for aggregating TCP-offloaded adapters for transacting data between communications systems comprising:
code means for aggregating the TCP-offloaded adapters by assigning a common Internet Protocol (IP) address to the TCP-offloaded adapters;
code means for selecting one of the aggregated TCP-offloaded adapters through which a connection between the communications systems is to originate;
code means for originating the connection using the selected TCP-offloaded adapter; and
code means for transacting data from the connection using the selected TCP-offloaded adapter.

7. The computer program product of claim 6 wherein the selecting code means includes code means for using a local port and a remote port to select the TCP-offloaded, the local port and the remote port being the ports through which the data transaction is to occur.

8. The computer program product of claim 7 wherein the selecting code means includes code means for assigning a local port through which the connection is to occur if a local port was not yet assigned.

9. The computer program product of claim 8 wherein the assigned local port is an ephemeral port.

10. The computer program product of claim 6 wherein the data includes incoming and outgoing data, the incoming data being divided into data packets, each packet having associated therewith a local port and a remote port for selecting a TCP-offloaded adapter through which to travel.

11. An apparatus for aggregating TCP-offloaded adapters for transacting data between communications systems comprising:
means for aggregating the TCP-offloaded adapters by assigning a common Internet Protocol (IP) address to the TCP-offloaded adapters;
means for selecting one of the aggregated TCP-offloaded adapters through which a connection between the communications systems is to originate;
means for originating the connection using the selected TCP-offloaded adapter; and
means for transacting data from the connection using the selected TCP-offloaded adapter.

12. The apparatus of claim 11 wherein the selecting means includes means for using a local port and a remote port to select the TCP-offloaded, the local port and the remote port being the ports through which the data transaction is to occur.

13. The apparatus of claim 12 wherein the selecting means includes means for assigning a local port through which the connection is to occur if a local port was not yet assigned.

14. The apparatus of claim 13 wherein the assigned local port is an ephemeral port.

15. The apparatus of claim 11 wherein the data includes incoming and outgoing data, the incoming data being divided into data packets, each packet having associated therewith a local port and a remote port for selecting a TCP-offloaded adapter through which to travel.

16. A system for aggregating TCP-offloaded adapters for transacting data with another system comprising:
at least one storage device for storing code data; and
at least one processor for processing the code data to aggregate the TCP-offloaded adapters by assigning a common Internet Protocol (IP) address to the TCP-offloaded adapters, to select one of the aggregated TCP-offloaded adapters through which a connection between the communications systems is to originate, to originate the connection using the selected TCP-offloaded adapter, and to transact data from the connection using the selected TCP-offloaded adapter.

17. The system of claim 16 wherein processing the code data to select one of the TCP-offloaded adapter includes processing the code data to use a local port and a remote port to select the TCP-offloaded, the local port and the remote port being the ports through which the data transaction is to occur.

18. The system of claim 17 wherein the code data to select one of the TCP-offloaded adapter includes processing the code data to assign a local port through which the connection is to occur if a local port was not yet assigned.

19. The system of claim 18 wherein the assigned local port is an ephemeral port.

20. The system of claim 16 wherein the data includes incoming and outgoing data, the incoming data being divided into data packets, each packet having associated therewith a local port and a remote port for selecting a TCP-offloaded adapter through which to travel.
